(19) United States
(12) Patent Application Publication
(10) Pub. No.: US 2025/0166064 A1
(43) Pub. Date: May 22, 2025

(54) SYSTEMS AND METHODS FOR CREATING VIRTUAL FUNGIBILITY BETWEEN NON-FUNGIBLE PRODUCTS

(71) Applicant: Icecap Diamonds, Inc., Denver, CO (US)

(72) Inventors: Jacques VOORHEES, Dillon, CO (US); Alex VOORHEES, Dillon, CO (US); Krista OLSON-BLUNDELL, Dillon, CO (US)

(73) Assignee: Icecap Diamonds, Inc., Denver, CO (US)

(21) Appl. No.: 18/839,291

(22) PCT Filed: Feb. 24, 2023
(86) PCT No.: PCT/US2023/063191

§ 371 Date: Aug. 16, 2024

Related U.S. Application Data
(60) Provisional application No. 63/268,463, filed on Feb. 24, 2022.

(51) Int. Cl. G06Q 40/04

(52) U.S. Cl. CPC G06Q 40/04; G06Q 2220/00

(57) ABSTRACT

Methods and systems for creating virtual fungibility between non-fungible products include receiving characteristics data associated with a plurality of non-fungible products, receiving industry standard pricing data associated with the plurality of non-fungible products, receiving non-industry standard pricing data from a data source separate from the industry standard pricing data, determining a first cell, from a plurality of cells, associated with the first non-fungible product, determining a weight factor for a first cell, determining a first par value for the first cell based on the industry standard pricing data, the non-industry standard pricing data, and the weight factor, associating a first identifier with the first non-fungible product, and generating a first value index for the first non-fungible product based on the first par value and a first offer price associated with the first non-fungible product.

### CROSS-REFERENCE TO RELATED APPLICATION

This application claims benefit to U.S. Provisional Patent Application No. 63/268,463, filed on Feb. 24, 2022, the entire contents of which are incorporated herein by reference.

### TECHNICAL FIELD

Various embodiments of this disclosure relate generally to creating fungibility between traditionally non-fungible products, and, more particularly, to systems and methods for providing a value based index for non-fungible products such as, but not limited to, loose polished diamonds, precious stones, etc.

### BACKGROUND

Liquidity (e.g., the ability for an asset or product to be quickly converted into a common medium-of-exchange such as cash) is an essential aspect of any investible market. Some commodities, such as gold, are considered liquid. This is because gold is a fungible (e.g., interchangeable) product, meaning that an ounce of gold can be replaced with another ounce of gold. An investor, in particular, can typically sell or purchase fungible products such as gold at an established market rate, with an expectation that the fungible product such as gold can be sold or purchased relatively quickly. This liquidity makes fungible products such gold a “more investable” asset.

Non-fungible goods are typically considered more challenging to invest in, due to a lack of liquidity, for example, the used car market. In the used car market, it may be possible to obtain data showing an average sale price for a particular used car based on factors such as the make, model, and year of the car. The price may further be modified by additional factors, such as mileage, condition, special accessories, and so forth. With this information, a car purchaser seeking a car can query different venues to determine which dealer or seller has the best deal on a car.

Conventional techniques fail to provide a sufficiently liquid, efficient, and transparent market for non-fungible goods (e.g., diamonds, real estate, unique collectibles, etc.) to allow non-fungible goods to become a more investable market asset.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure, methods and systems are disclosed for creating fungibility between traditionally non-fungible products.

In one aspect, a method for creating virtual fungibility between non-fungible products includes receiving characteristics data associated with a plurality of non-fungible products; receiving industry standard pricing data associated with the plurality of non-fungible products; receiving non-industry standard pricing data from a data source separate from the industry standard pricing data; determining a first cell, from a plurality of cells, associated with the first non-fungible product; determining a weight factor for a first cell; determining a first par value for the first cell based on the industry standard pricing data, the non-industry standard pricing data, and the weight factor; associating a first identifier with the first non-fungible product; and generating a first value index for the first non-fungible product based on the first par value and a first offer price associated with the first non-fungible product.

In another aspect, a method for creating virtual fungibility between diamonds includes receiving characteristics data for each diamond of a plurality of diamonds; receiving industry pricing data associated with the plurality of diamonds; receiving non-industry pricing data from a data source separate from the industry pricing data; determining a respective cell for each diamond of the plurality of diamonds; determining a weight factor for each respective cell; determining par values for each respective cell based on the characteristics data, the industry pricing data, the non-industry pricing data, and respective weight factors for each of respective cell of the plurality of cells; generating an identifier for each diamond of the plurality of diamonds; receiving an offer price associated with each generated identifier; determining a value index for each generated identifier based on the determined par value and the offer price associated with each generated identifier; ranking each generated identifier based on a corresponding value index of each generated identifier; and presenting the ranking of the generated identifiers on an online marketplace.

In another aspect, a method for creating virtual fungibility between non-fungible products includes receiving characteristics data for each non-fungible product of a plurality of non-fungible products; receiving industry pricing data associated with the plurality of non-fungible products; receiving non-industry pricing data from a data source separate from the industry pricing data; determining a respective cell, from a plurality of cells, for each non-fungible product of the plurality of non-fungible products; determining a weight factor for each respective cell of the plurality of cells; determining par values for each respective cell of the plurality of cells based on the characteristics data, the industry pricing data, the non-industry pricing data, and respective weight factors for each of non-fungible product of the plurality of non-fungible products; generating a blockchain non-fungible token (NFT) for each non-fungible products of the plurality of non-fungible products; receiving an offer price associated with each generated NFT; determining a value index for each generated NFT based on the determined par value and the offer price associated with each generated NFT; ranking each generated NFT based on a corresponding value index for each generated NFT; and presenting the ranking of the generated NFTs on an online marketplace.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment in which systems methods and other aspects of the present disclosure may be implemented.

FIG. 2 depicts an example characteristics chart for diamonds, according to embodiments of the present disclosure.

FIG. 3 depicts an example marketplace for non-fungible products, according to embodiments of the present disclosure.

FIG. 4 depicts another example marketplace for non-fungible products, according to embodiments of the present disclosure.

FIG. 5 depicts a value index ranking interface for non-fungible products, according to embodiments of the present disclosure.

FIG. 6 depicts another value index ranking interface for non-fungible products, according to embodiments of the present disclosure.

FIG. 7 depicts a flowchart for determining value indexes for non-fungible products, according to embodiments of the present disclosure.

FIG. 8 depicts a value index generator, according to embodiments of the present disclosure.

FIG. 9 depicts a data flow for training a machine learning model, according to embodiments of the present disclosure.

FIG. 10 depicts an exemplary computer device or system, in which embodiments of the present disclosure, or portions thereof, may be implemented.

Like reference numbers and designations in the various drawings indicate like elements.

### DETAILED DESCRIPTION OF EMBODIMENTS

Non-fungible items may be considered to lack liquidity compared to fungible items. For example, diamonds are valuable commodities (e.g., items) which are non-fungible because each diamond is unique. Every diamond has characteristics that may be evaluated by industry experts. For example, diamonds are typically evaluated on the Gemological Institute of America (GIA) scale by color, clarity, cut, and carat weight (e.g., the “4Cs”), which is also referred to as GIA's International Diamond Grading System™. Color may be evaluated on a GIA scale from D to Z, where D is closest to colorless (considered more valuable) and Z is a very light yellow or brown (considered less valuable). Clarity may be evaluated on eleven grades, ranging from FL (flawless) to I3 (inclusions obvious to the naked eye). The cut of a diamond is evaluated based on how well the facets of the diamond interact with light to create a desirable visual effect, and is most often evaluated on several factors ranging from Excellent to Poor. In addition to the 4Cs, other factors may also be considered in valuing a diamond, for example, market supply and demand, sourcing, and so forth. A diamond expert may be able to provide a rough wholesale value or price for a diamond based on the 4Cs and other factors. In standard diamond industry practice, diamonds are categorized into “cells” for easier comparison and pricing. For example, a cell might be defined as any diamond graded Color: G; Clarity: VS2; Cut: Triple Excellent, and 1.00 to 1.09 carats (cts.). However, multiple factors outside of the 4Cs may significantly impact the approximate value for any given diamond within a cell. For example, gemological factors, beyond the 4Cs, can affect value.

Because diamonds are traditionally considered non-fungible, it is difficult to attract investors due to reduced liquidity resulting from the uncertainties in pricing and/or the difficulties of creating a low-spread, efficient, two way market as is available for most fungible, “investable” products. These disparities in pricing make it difficult for investors to know approximately how much a particular diamond may sell for at a given time, or whether an offer price for a diamond is a good deal or a bad deal. While typical consumers of diamonds may care about the particulars of a diamond (for example, the type of cut or color), an investor may be less interested in the details and may be more interested in whether the diamond is a good value for the price.

Although the disclosure provided herein generally discusses diamonds as an example, it will be understood that the systems and techniques disclosed herein may be implemented for any non-fungible product such as, but not limited to, vehicles, beverages (e.g., wine), consumables, real estate, precious art, or the like.

As used herein, virtual fungibility may be a state in which non-fungible items can nonetheless be bought/sold on the basis of, for example, one-dimensional pricing/value considerations. Virtual fungibility for a traditionally non-fungible item may be implemented by discounting differences which may traditionally cause non-fungibility. According to implementations disclosed herein, virtual fungibility may be crated for non-fungible products such as diamonds such that an efficient market of narrow bid-ask spreads can be applied to diamonds generally, regardless of which cell they are classified in. This virtual fungibility may a prerequisite to creating a viable, liquid, market for investors.

There are benefits to making non-fungible products available as a liquid investment product for an investor with a diversified portfolio. For example, diamonds are one of the hardest natural occurring material on Earth, making them highly resistant to decay. Further, unlike commodities such as gold, diamonds can be easily transported discretely, with minimal cost. For example, while $1,000,000 worth of gold may weigh upwards of 50 pounds and be extremely bulky, the same cash equivalent of diamonds might weigh only a few ounces and be carried in a person's pocket. Diamonds as an investment can also be worn as jewelry and actually used and displayed by an investor.

Traditional auction and diamond marketplaces suffer from many drawbacks, and they do not create an efficient investable market for investors. For example, certain industry pricing reports are known to be inaccurate and inconsistent, and actual prices in some cases vary as much as 50% from prices listed on such reports. Further, while there may exist accurate lists for diamond pricing, it is difficult for investors to control all the underlying variables present regarding the purchase of any specific diamond, such as, for example, the possibility of counterfeit certificates, damage to the stone, changes to grading standards by the GIA over time, borderline stones (e.g., stones that do not fit cleanly into one of the categories), or other gemological properties (clouds, graining, etc.) that are not covered by the 4Cs. Thus, even with an accurate price for each cell, the diamonds within each cell may have such significant variance, such that it is difficult to create an investable market.

As used herein, a value index for a non-fungible good may be a value (e.g., a ratio) associated with the non-fungible good based on a par value (as further discussed herein) for a cell associated with the non-fungible good and an offer price associated with the non-fungible good. Accordingly, the value index may be based on a par value normalized across all non-fungible goods of the same type and may further be based on an offer price associated with a specific non-fungible good. According to certain aspects of the disclosure, methods and systems are disclosed for value indexing of non-fungible products, e.g., diamonds, to create a virtual fungible market (e.g., a market having virtual fungibility, as disclosed herein). There is a need to make non-fungible commodities such as diamonds investible. However, conventional techniques for online diamond sales may not be suitable. For example, conventional techniques do not provide investors with virtual fungibility of diamonds and a system for easily purchasing and selling diamonds at an accurate market rate in real-time. Accordingly, improvements in technology relating to value indexing of non-fungible goods is disclosed herein.

As used herein, a par value may be determined for each of a plurality of cells associated with a non-fungible product type. The number of cells associated with a non-fungible product type may correspond to all or a subset of the various permutations of properties associated with a non-fungible product type. For example, a number of cells (e.g., less than approximately 100, less than approximately 500, less than approximately 1000, greater than approximately 1000, etc.) may be associated with diamonds based on properties of the diamonds. As a more specific example, approximately 500 cells may be associated diamonds based on various permutations of the 4Cs. The 500 cells may be based on a subset of each of the possible permutations of diamond properties (e.g., one or more cut-quality grades may be removed, one or more clarity grades may be removed, etc.). A given diamond may be associated with one specific cell of the 500 cells and may not be associated with more than one cell. Multiple diamonds may be associated with the same specific cell of the 500 cells.

According to an implementation, non-fungible products that meet minimum thresholds may be considered for virtual indexing. Non-fungible products that do not meet minimum thresholds may be excluded from virtual indexing. For example, diamonds that do not meet minimum 4C criteria (or other disqualifying gemological parameters) may not be associated with any cell of the 500 cells discussed in the example above. Accordingly, a value index may not be generated for such diamonds. Accordingly, a cell of a plurality of cells may be identified for a non-fungible product that meets the minimum thresholds for the corresponding non-fungible product type.

As will be discussed in more detail below, aspects of this disclosure describe systems and methods for value indexing non-fungible products to create virtual fungibility using a proprietary pricing algorithm. According to aspects, blockchain non-fungible tokens (NFTs) and machine learning may be used for value indexing non-fungible products to create virtual fungibility. By training a machine-learning model, e.g., via supervised or semi-supervised learning, to learn associations between information related to industry and non-industry pricing for prior diamonds and corresponding characteristics, information for the prior diamonds data, and one or more par values corresponding to one or more diamonds and corresponding characteristics information for each of the one or more diamonds data, the trained machine-learning model may be usable to value index non-fungible products.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

A “blockchain” as used herein refers to a distributed ledger (e.g., a shared permissioned ledger, a public ledger, and so forth) that may record transactions between parties to a payment transaction in a verifiable and a permanent way. Because the blockchain is open (e.g., accessible to the public), every transaction recorded on the blockchain is transparent and visible to the public. A blockchain is typically operated by multiple parties that come to a consensus on each transaction recorded to the chain. Computers that maintain the blockchain ledger and approve transactions are referred to as “nodes” or “blockchain nodes.” A blockchain maintains a growing list of ordered records, with each record referred to as a “block.” Each block in the blockchain may include both a timestamp and a link to a previous block, and blocks are generally not alterable retroactively once they are recorded on the chain. While each block on the blockchain may be owned or accessed by an entity or person, the block may only be accessed by a person or entity with a private key corresponding to the block. Each block on the blockchain may be likened to a digital safety deposit box. Each box may contain a digital asset (e.g., currency, securities, loyalty points, contracts, and so forth). Each box is secured with a cryptographic private key (for example, a secret number). The owner of a box may use their cryptographic private key to access their box and transfer a digital asset to a second box that belongs to a recipient, where the second box is secured by a cryptographic private key belonging to the recipient. The recipient may then retrieve the digital asset from their safety deposit box using their own cryptographic private key. Unlike safety deposit boxes, however, blockchain transactions, as explained above, may be accessed by the public.

A blockchain typically may include one or more features, as further discussed herein. For example, a blockchain may include a database, and tabular schema may be used to encode core data types on top of a traditional database. In these examples, tables may consist of blocks, which may be bundles of transactions. Furthermore, such embodiments may be configured so that blockchain transactions or transfers may be all or nothing. In some embodiments, a blockchain may be rendered immutable, ensuring that the data stored in a block cannot be changed. Each block in the chain may include reference to the previous block; as a result, in chains with high transaction rates, the block may be more securely linked to previous blocks. The block may also be replicated numerous times, ensuring that the integrity of the block is maintained even if one or more nodes of the blockchain are compromised or fail. Cryptography may be implemented to ensure that users of a blockchain may only be able to edit the parts of the blockchain that they “own” (where ownership is established by possessing unique private keys corresponding to that part of the blockchain as explained above). Cryptography may also ensure that copies of the distributed blockchain are kept in sync. Distributed ledgers (“shared ledgers”) may also be used for transaction integrity. Accordingly, ledgers may be maintained by multiple parties across multiple computing devices (e.g., nodes). A consensus protocol may additionally be followed by each party to maintain a consistent view of the ledger. Distributed ledgers provide for greater resiliency against malicious attacks or system failures. Furthermore, a blockchain may be “permissioned” such that access is only granted to specific participants.

In some embodiments, a blockchain network may be based on bitcoin, litecoin, Ethereum, Tether, EOS.IO, or on Ripple. Ripple is a real-time gross settlement system (RTGS) currency exchange and remittance network enabling secure, instant, and cheap global financial transactions with no chargebacks. Such blockchain networks may support tokens representing cryptocurrencies, commodities, and so forth. These blockchain networks may further be based around a shared public blockchain and/or shared ledger, which may use a consensus process that may allow for payments to occur in a decentralized, distributed process. While the above blockchain networks are used as example blockchain networks or platforms to serve the function of the settlement or transfer of funds, currency, and/or cryptocurrency, it is contemplated that similar blockchain networks that provide the benefits described above may be used. The methods disclosed herein may be implemented with any type of digital currency, including, for example, bitcoin, litecoin, Ether, XRP, Tether, EOS, polygon, USDC and so forth.

Ethereum is a blockchain that runs via a computer known as the Ethereum Virtual Machine (EVM). Each blockchain node on the Ethereum blockchain contains a copy of the EVM, and network interactions (e.g., transactions) are verified by each node thereof. This verification process is often performed by “miners,” which are nodes on the network that create blocks of transactions to be added to the blockchain. The verification process may also be performed with a proof-of-stake consensus process, commonly referred to as “staking.” In staking, a node meeting certain requirements on the blockchain may be semi-randomly selected to be a “validator.” The validator node is able to validate transactions and add or confirm blocks to the blockchain, and is rewarded for being a validator with cryptocurrency, i.e., ETH. In some cases, a block requires a majority of a group of validators to validate a block or transaction on the blockchain before it can be finalized. In some embodiments, the chances for being selected as a validator may increase by pledging or staking cryptocurrency such as ETH. Each transaction on the Ethereum blockchain is entirely public, resulting in a history of all network transactions that cannot be tampered with or modified. Ethereum is further associated with a cryptocurrency called Ether (e.g., ETH). Transactions on the network are typically validated by miners or other methods as described above, and a fee is assessed with each transaction that is paid to the miners, commonly known as “gas,” which may fluctuate with demand.

Due to network congestion, standard Ethereum blockchain transactions may result in higher gas fees, which is particularly problematic in a lower margin market, for example, diamond investing. As a result, layer-2 or “side-chain” solutions exist for reducing traffic on Ethereum. A side-chain is a separate blockchain that acts as an “extension” of the original blockchain. For example, Polygon is a known layer-2 scaling solution for the Ethereum blockchain. The benefit of using sidechains is a reduction in gas fees (as the transaction logic itself occurs in the sidechain or second layer) while still maintaining the protection and immutability of the original main blockchain.

As used herein, a non-fungible token (NFT) refers to unique, non-interchangeable unit of data stored on a blockchain. A non-fungible token may be sold or traded, typically in a digital marketplace. NFTs may be created using cryptographic hashes on sets of data linked to previous records on a blockchain. There are multiple standards that may be implemented with NFTs, including Ethereum Request for Comments (ERC), for example, ERC-20, ERC-721, ERC-998, and ERC-1155. ERC-721 is a well-known standard that applies to building NFTs on Ethereum. Each NFT is unique, and may be used to associate with or represent a digital or physical item, for example, artwork, collectibles, gems, utility tokens, and so forth.

Terms like “provider,” “merchant,” “vendor,” or the like generally encompass an entity or person involved in providing, selling, and/or renting items to persons such as a seller, dealer, renter, merchant, vendor, or the like, as well as an agent or intermediary of such an entity or person. An “item” or “product” generally encompasses a good, service, or the like having ownership or other rights that may be transferred. As used herein, terms like “user” or “customer” generally encompasses any person or entity that may desire information, resolution of an issue, purchase of a product, or engage in any other type of interaction with a provider. The term “browser extension” may be used interchangeably with other terms like “program,” “electronic application,” or the like, and generally encompasses software that is configured to interact with, modify, override, supplement, or operate in conjunction with other software. As used herein, terms such as “marketplace” or the like generally encompass a place where items or products may be traded or exchanged, for example, a website that offers NFTs for sale in exchange for currency or cryptocurrency.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

A value index par value may be determined for each cell for a given non-fungible product type. Continuing the example provided above, approximately 500 cells for diamonds may be identified based on a subset of the various permutations of the 4Cs associated with diamonds and/or based one on or more other restrictions. Each cell may correspond to a different permutation of the 4Cs. A value index par value may be determined for each cell (e.g., each cell of the 500 cells). The value index par value may be based on the permutations associated with a given cell and based on one or more of industry standard pricing data, non-industry standard pricing data, characteristics data, and/or external factors, as further discussed herein.

According to implementations of the disclosed subject matter, instead of a price, a relative value (e.g., a value index) for a non-fungible product may be used to facilitate a transaction. A value indexing engine (e.g., a proprietary pricing algorithm) may be used to determine a value index for a non-fungible product. The value index may be based on a price (e.g., an offer price) for a non-fungible product in comparison to a value index par value (a par value) for the cell associated with the non-fungible product. A value index par value for the cell may be determined based on factors applied by the value indexing engine, as further disclosed herein. The value index may be a score, numerical value, a tier, a rank, or the like based on the one or more factors and may allow comparison of two or more non-fungible products in a non-fungible product category (e.g., diamonds, real estate, etc.). The value index par value may be determined for each cell in a non-fungible product category such that the par value for each cell in the non-fungible product category is determined using the same standard value index engine and/or factors. The par value for a given cell may be associated with each non-fungible product associated with the given cell such that a value index for a non-fungible product may be based on its respective cell's par value and a price (e.g., offer price) for the non-fungible product. Accordingly, multiple non-fungible products in a given non-fungible product category may be compared to each other based on their value index such that non-fungible products having varying properties may be compared to each other based on a standard value indexing mechanism, across the non-fungible product category.

Accordingly, systems and techniques disclosed herein provide a value index system to create virtual fungibility between products that are non-fungible, allowing operation of an investor-oriented market for a given non-fungible product category.

As an illustrative example related to diamonds, traditional diamond sales are based on properties of a diamond (e.g., 4Cs) and a price for the diamond. The price for the diamond is generally non-standard and may be based on the cost a wholesaler paid, margins a vendor is seeking, marketing, incentives, etc. Accordingly, a first diamond having given properties may be sold for a first price and a second diamond having the same given properties may be sold for a second price different than the first price. Further, it is difficult to compare diamonds having different properties based on the variability in properties across the diamonds. Traditional non-standardized pricing models make it difficult to compare prices for diamonds having varying properties. Such non-standardized pricing models result in an inefficient marketplace as prices of diamonds having same or similar properties can vary based on non-standardized pricing models and diamonds having varying properties cannot accurately be compared to each other. Rather, in accordance with the systems and techniques disclosed herein, standardized value index par values for cells may be used to determine value indexes for diamonds having the same or substantially similar properties and/or diamonds having varying properties. The standardized par values may be determined using one or more machine learning models that output par values for cells based on one or more of industry standard pricing data, non-industry standard pricing data, characteristics data, and/or external factors, as further discussed herein. A buyer may evaluate a diamond based on its value index (e.g., rather than its price), as determined based on a corresponding cell's par value and a price (e.g., offer price) associated with the diamond, allowing value based transactions of diamonds. Further, techniques disclosed herein provide a relative value index for diamonds having different properties (e.g., associated with different cells). Such a relative value index may allow an investor to compare diamonds having different properties based on a diamond's value index relative to value indexes of one or more other diamonds. Accordingly, values for diamonds having different properties may be compared to each other based on their relative value indexes. The ability to implement such comparisons may create the virtual fungibility described herein.

Similarly, as another illustrative example related to real estate, traditional real estate sales are based on properties of a real estate asset and a negotiated price based on the same. The price for a real estate asset is generally non-standard and may be based on sales histories, comparable sales, negotiation, incentives, etc. Accordingly, a first real estate asset having given properties may be sold for a first price and a second real estate asset having the same given properties may be sold for a second price different than the first price. Further, it is difficult to compare real estate assets having different properties based on the variability in properties across the real estate assets as traditional non-standardized pricing models make it difficult to compare prices for real estate assets having varying properties. Such non-standardized pricing models result in an inefficient marketplace as prices of real estate assets having same or similar properties can vary based on non-standardized pricing models and real estate assets having varying properties cannot be compared to each other. Rather, in accordance with the systems and techniques disclosed herein, standardized value index par values for cells may be used to determine value indexes for real estate assets having the same or substantially similar properties and/or real estate assets having varying properties. The standardized par values may be determined using one or more machine learning models that output par values for cells based on one or more of industry standard pricing data, non-industry standard pricing data, characteristics data, and/or external factors, as further discussed herein. A buyer may evaluate a real estate asset based on its value index (e.g., rather than its price), as determined based on a corresponding cell's par value and a price (e.g., offer price) associated with the real estate asset, allowing value based transactions of real estate assets. Further, techniques disclosed herein provide a relative value index for real estate asset having different properties (e.g., associated with different cells). Such a relative value index may allow an investor to compare real estate asset having different properties based on a real estate asset's value index relative to value indexes of one or more other real estate assets. Accordingly, values for real estate assets having different properties may be compared to each other based on their relative value indexes.

Accordingly to implementations disclosed herein, non-fungible products may transact in a virtual-fungibility market based on value indexing. In such a market, every willing buyer may be a potential match for every willing seller. Buyers and sellers may be matched as a buyer may buy at the best value index no matter what is being sold, and the seller may be is willing to sell at the best value index based price. A virtual-fungibility market may provide efficiency and minimize spread between buy and sell offers, as is the case for fungible markets. In a virtual-fungibility market, every buyer may be matched automatically with every seller based on value indexes (e.g., instead of non-fungible good properties being additional variables).

The virtual-fungibility market disclosed herein may provide close to the same efficiency as fungible markets (e.g., currency, digital coins, shares, gold, etc.). The virtual-fungibility market may use value indexing to provide an ability to portray each non-fungible product, in a given non-fungible product category, offered for sale as a ratio of its asking price and a determinable industry-standard par (e.g., average, mean, etc.) value for the cell associated with the non-fungible product. According to an implementation, a critical mass of buyers and sellers buying and selling based on value indexing will cause the virtual-fungibility market to function as a fungible market. Or, put another way, without value index pricing creating virtual fungibility, a non-fungible product buyer may generally be interested in only a certain type of non-fungible product. A seller may only offer a certain type of non-fungible product for sale such that only limited sellers may offer specifically the non-fungible product of interest to the buyer. Accordingly, it may be difficult for a buyer to find a seller selling the non-fungible product of interest to the buyer. Even if a seller offers a non-fungible product that a buyer is interested in, there may not be much competition for the buyer and/or seller as the specific non-fungible product may be rare. By contrast, in a virtual-fungibility market, every buyer may be interested in what every seller offers, and every seller may offer something of interest to every buyer. As disclosed herein, the only variable between different non-fungible products may be a corresponding value index. Rather than the difficulties inherent in buyers finding sellers for specific non-fungible products, all buyers and sellers may be able to interact together, in aggregate, as is the case in a fungible-product marketplace. Having a threshold number of buyers and sellers that can interact with each other, competitive pressure is inherent and efficiency is created.

According to an implementation, as discussed herein, non-complaint non-fungible goods (e.g., outlier non-fungible goods) may be excluded from the virtual-fungibility market. Such non-compliant non-fungible goods may be excluded based on exclusion properties associated with the non-complaint non-fungible goods. For example, diamonds with defects (e.g., having outlier gemological characteristics) may be flagged based on data received at the value indexing engine.

In an exemplary use case, a value indexing engine (e.g., a proprietary pricing algorithm) may receive data regarding characteristics corresponding to each of one or more diamonds, for example, the 4Cs of each diamond. The value indexing engine may also receive industry standard pricing data (such as from a publicly available industry report), non-industry standard pricing data (for example, data relating to supply and demand for a particular diamond shape), and a weight factor (for example, approximately 10%). Based on this data, the value indexing engine may generate a par value for each cell associated with respective diamonds.

The value indexing engine may correlate the characteristics (e.g., diamond properties) corresponding to a given cell with corresponding industry standard pricing data for that cell, with corresponding non-industry standard pricing data for the cell, and/or a weight factor for the cell.

According to an implementation of the disclosed subject matter, each diamond may be associated with a corresponding identifier. The identifier may be a unique identifier, a digital identifier, a proof of title, a certificate of ownership, may be based on a blockchain identifier (e.g., an NFT), a GIA number, or the like. For example, each diamond may be associated with an NFT, and each NFT may be displayed on a marketplace. The owner of each NFT may include an “offer price” with the NFT and offer the NFT for sale on the marketplace. It will be understood that although NFTs are generally provided as examples herein, any applicable identifier may be used to identify a non-fungible product.

The value indexing engine may generate a value index for each non-fungible product in a given non-fungible product category. The value index for a given non-fungible product may be based on the par value for a cell that the non-fungible product is associated with and a price associated with the non-fungible product. Based on the value index generated for each non-fungible product, the non-fungible product may be ranked on the marketplace, such that the non-fungible product with the best value index is presented at the top of the ranking. Furthermore, in some embodiments, the value indexing engine may generate a suggested offer price for the owner of each non-fungible product, where the suggested sales price is one sufficient to result in a higher value index than the current non-fungible product value index. In this manner, a seller will always know how best to price their diamond for, resulting in a fungible market. Similarly, a buyer or investor seeking to purchase a diamond will always know that the diamond with the highest value index offers the “best” deal. The “best” deal may refer to the non-fungible product that is the most discounted, the best value for the cost, and/or is most likely to yield the most profit as an investment if purchased at the sales price offered. For example, a non-fungible product offered for sale at $2,000 associated with a cell par value of $2,200 may be the best deal for an investor compared to another non-fungible product offered for sale at $1,000 associated with cell a par value of $900. In this manner, through the use of the value indexing engine, the non-fungible product being offered at the best deal is always offered at the top relative to the par value in real-time value index based updates, such that a more liquid and secure market for diamond investors is generated. In some cases, the par values may be generated using a trained machine learning engine, as further disclosed herein.

In another exemplary use case, a diamond marketplace may be implemented using a value indexing engine. The value indexing engine may receive accurate industry pricing sheet data which contains wholesale prices obtained using a consistent methodology. A process for screening diamonds, before the diamonds are introduced to the marketplace, may be implemented to exclude any diamonds with negative gemological characteristics that are not observed or quantified within the 4Cs, as removing such diamonds improves the consistency of diamonds on the marketplace. A second screening process may be implemented to audit and verify the accuracy of an original GIA certificate for a diamond. For example, as much as 80% of GIA certificates on the market may actually be inaccurate based on traditional GIA grading standards and/or may be counterfeit. Further, a diamond that has been graded may have changed since its grading occurred, for example, it may have been damaged. Next, diamonds that pass the screening processes, are ensured to be properly graded, and are of the quality specified may be transported and stored in a secure location to ensure its safety. If the diamond is removed from the secure location, it may be audited and subjected to the above processes again before it can be made part of an investor-focused marketplace.

Next, a process for ensuring that the diamond being traded on the marketplace is the same as the diamond that has been screened/audited and stored in the secure location may be implemented. This process may be implemented using secure identifiers (e.g., digital identifiers, NFTs, etc.), which provide immutable proof of which diamond is owned by which owner and which diamond corresponds to which grading certificate. Associating the securely stored diamond with a secure identifier (e.g., an NFT which is securely protected with blockchain technology), may mitigate or prevent modification of the association or the identifier. The marketplace may be configured to allow trading using an identifier (e.g., NFT) through multiple transactions, while still ensuring the safety and value of the securely stored diamond.

Further, the marketplace may be configured to allow traders to make rational bids and offers using the identifiers (e.g., NFTs), using the virtual fungibility marketplace implementation described herein. Once one or more diamonds have been securely audited and stored, and identifiers (e.g., NFTs) are generated and shared on the marketplace, the value indexing engine may be implemented on a one-dimensional scale, e.g., a value relative to par. For example, a diamond “x” may have a value index of −0.12%, and a diamond “y” may have a value index of −0.14%, both evaluated on the same scale. Although X and Y may be diamonds with different parameters (e.g., different cells), they are reduced to a single dimension (their value index). The value index for a given diamond may indicate a current value of the diamond relative to a defined standard (par). The value index may be a number, a tier, a rank, a ratio, or the like and may allow comparison between values of two or more diamonds. A lower value index may indicate a “better deal” or a higher value index may indicate a “worse deal”. For simplicity, as described herein, a lower value index indicates a higher value or “better deal”. In the example provided above, diamond “y” has a higher value as it has a lower value index of −0.14% in comparison to diamond “x” which has a lower value index of −0.12%. The value index based process removes uncertainty and creates virtual fungibility for diamonds, resulting in an investable market.

While the example above is directed to diamonds, it should be understood that techniques disclosed herein may be adapted to any suitable type of non-fungible item, including other types of gems or other non-fungible commodities or items. It should also be understood that the examples above are illustrative only. The techniques and technologies of this disclosure may be adapted to any suitable activity.

One or more machine learning techniques that may be adapted to determine a par value for one or more cells for a given non-fungible product category. As will be discussed in more detail below, machine learning techniques to determine a par value for a cell, may include one or more aspects according to this disclosure, e.g., a particular selection of training data, a particular training process for the machine-learning model, operation of a particular device suitable for use with the trained machine-learning model, operation of the machine-learning model in conjunction with particular data, modification of such particular data by the machine-learning model, etc., and/or other aspects that may be apparent to one of ordinary skill in the art based on this disclosure.

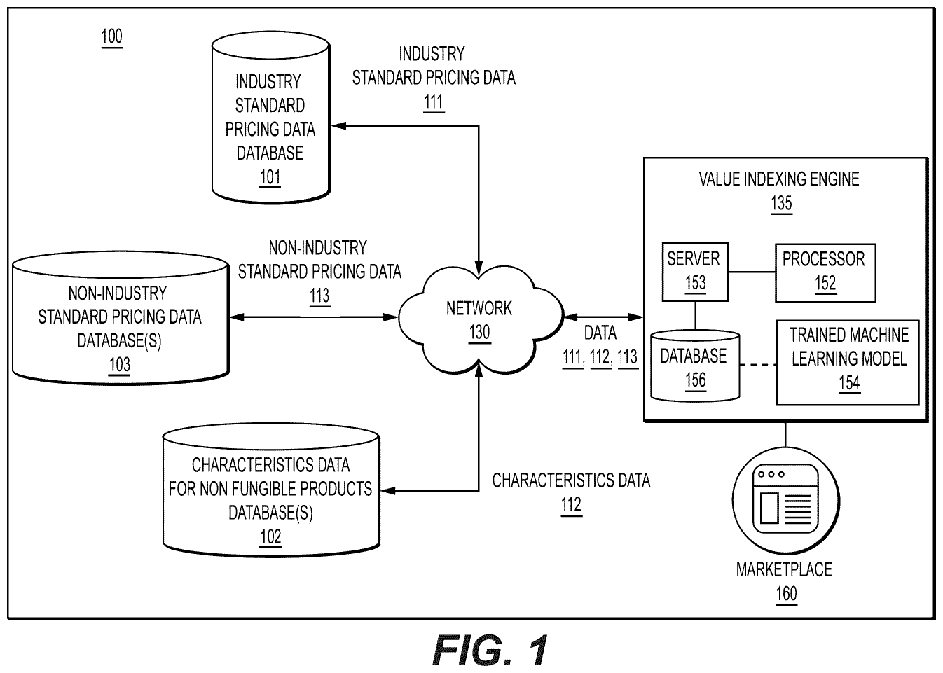

FIG. 1 depicts an exemplary environment 100 that may be utilized with techniques presented herein. An industry standard pricing data database 101, a non-industry standard database 103, and a characteristics data for non-fungible products database 102, may communicate data across an electronic network 130. For example, industry standard pricing data 111, non-industry standard pricing data 113, and characteristics data 112 may be transmitted over a network to the value indexing engine 135. Value indexing engine may include one or more processors 152, servers 153, and/or trained machine learning models 154 and may generate value indexes for non-fungible products, as further disclosed herein.

As will be discussed in further detail below, one or more value indexing engines 135 may communicate with one or more of the other components of the environment 100 across electronic network 130. In some embodiments, the components of the environment 100 are associated with a common entity, e.g., a vendor or merchant of a non-fungible product, or the like. In some embodiments, one or more of the components of the environment is associated with a different entity than another. The systems and devices of the environment 100 may communicate in any arrangement. As will be discussed herein, systems and/or devices of the environment 100 may communicate in order to one or more of generate, train, or use a machine-learning model or blockchain for value indexing of non-fungible products, among other activities.

In various embodiments, the electronic network 130 may be a wide area network (“WAN”), a local area network (“LAN”), personal area network (“PAN”), or the like. In some embodiments, electronic network 130 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

As discussed in further detail below, the value indexing engine 135 may one or more of (i) generate, store, train, or use a machine-learning model configured to determine a par value and/or value index for one or more non-fungible products. The value indexing engine 135 may include a machine-learning model and/or instructions associated with the machine-learning model, e.g., instructions for generating a machine-learning model, training the machine-learning model, using the machine-learning model etc. The value indexing engine may include instructions for retrieving pricing data and characteristics data 112, adjusting pricing data and characteristics data 112, e.g., based on the output of the machine-learning model, and/or operating a display to output pricing data and characters data, e.g., as adjusted based on the machine-learning model. The value indexing engine 135 may include training data, e.g., information related to industry and non-industry pricing for prior diamonds and corresponding characteristics information for the prior diamonds, and may include ground truth, e.g., data that includes one or more par values corresponding to one or more diamonds and corresponding characteristics information for each of the one or more diamonds.

In some embodiments, a system or device other than the value indexing engine 135 is used to generate and/or train the machine-learning model. For example, such a system may include instructions for generating the machine-learning model, the training data and ground truth, and/or instructions for training the machine-learning model. A resulting trained-machine-learning model may then be provided to the value indexing engine 135.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between training data, e.g., information related to industry and non-industry pricing for prior diamonds and corresponding characteristics information for the prior diamonds, and may include ground truth, e.g., data that includes one or more par values corresponding to one or more diamonds and corresponding characteristics information for each of the one or more diamonds, such that the trained machine-learning model is configured to determine an output a par value or value index in response to the input of characteristics data 112 based on the learned associations.

For example, in some embodiments, the machine-learning model of the value indexing engine 135 may include a Recurrent Neural Network (“RNN”). Generally, RNNs are a class of feed-forward neural networks that may be well adapted to processing a sequence of inputs. In some embodiments, the machine-learning model may include a Long Shor Term Memory (“LSTM”) model and/or Sequence to Sequence (“Seq2Seq”) model. An LSTM model may be configured to generate an output from a sample that takes at least some previous samples and/or outputs into account. A Seq2Seq model may be configured to, for example, receive a sequence of non-optical in vivo images as input, and generate a sequence of locations, e.g., a path, in the medical imaging data as output.

Although depicted as separate components in FIG. 1, it should be understood that a component or portion of a component in the environment 100 may, in some embodiments, be integrated with or incorporated into one or more other components. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized for value indexing of non-fungible goods to create virtual fungibility is discussed in further detail in the methods below. In the following methods, various acts may be described as performed or executed by a component from FIG. 1, such as the value indexing engine 135, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

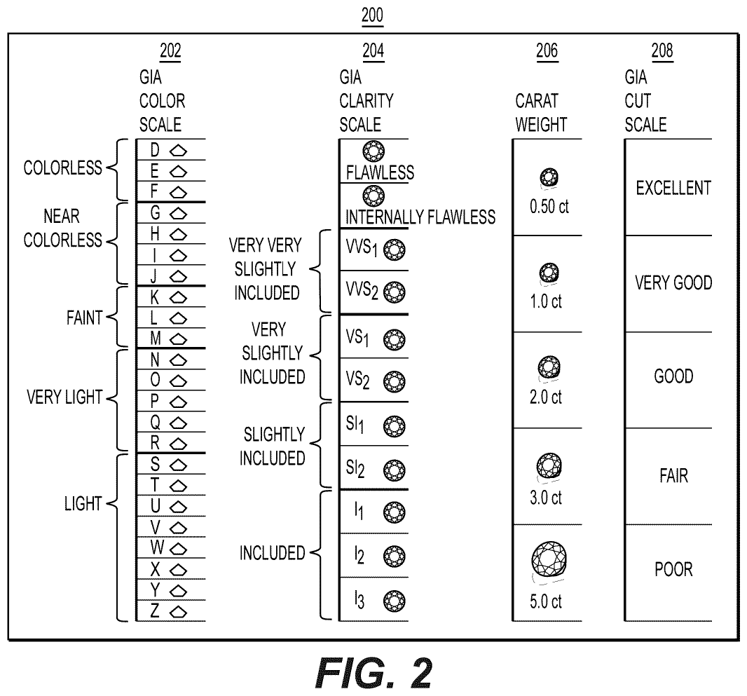

A computer-implemented process for creating virtual fungibility between non-fungible products is disclosed. At a first step, a plurality of cells corresponding to non-fungible product properties for a given non-fungible product category may be identified. Each compliant non-fungible product in the non-fungible product category may be associated with a corresponding cell based on matching the non-fungible product's properties to a corresponding cell's properties. A value indexing engine 135 may receive characteristics data 112 associated with a plurality of non-fungible products. Characteristics data 112 may be, for example, data that defines, characterizes, evaluates, categorizes, and/or measures a non-fungible product or good. For example, in embodiments where the non-fungible product is a diamond, the characteristics data 112 may include industry measured characteristics such as the 4Cs for the diamond. For example, the characteristics data 112 may include data representing the diamond as it would be evaluated by the GIA, such as the carat weight (e.g., 0.19 CT), the cut (e.g., Excellent), the color (e.g., E), and the clarity (e.g., WS1 or “Very Very Slightly Included”). An exemplary diamond grading chart made available by the GIA is provided in chart 200 of FIG. 2.

As shown in chart 200 of FIG. 2, characteristic data for a diamond may include values associated with one or more of a color scale 202, a clarity scale 204, a carat weight 206, and/or a cut scale 208. Such characteristics data 112 for the diamond may be provided to value indexing engine 135.

Next, the value indexing engine 135 may receive industry standard pricing data 111 associated with the plurality of non-fungible products. For example, there may exist industry-wide standards that issue weekly reports indicating standard prices for diamonds at a wholesale level, separated into categories. Examples of such pricing data include the Rapaport© report, IDEX, Polygon Diamond Price Report, and others. Thus, as discussed further below, a par value for a cell that a diamond is associated with may be generated based in part on the industry identified price for a particular diamond. In some embodiments, the industry standard pricing data 111 may be modified. For example, there may exist errors or anomalies that impact the pricing of diamonds, or there may be outliers that skew the industry standard pricing data 111 in a way that makes it less accurate or reliable. The industry pricing can be modified by, for example, by removing a percentage of the highest priced and lowest priced outliers in a given cell of a report. Alternatively, or in addition, a machine learning model (e.g., a machine learning model associated with value indexing engine 135) may receive inputs of industry pricing and/or non-industry pricing and may determine modifications to the industry pricing. For example, the machine learning model may be trained (e.g., supervised training) based on historical modifications to industry pricing (e.g., based on tagged historical received pricing data, tagged historical modifications, etc.).

Next, the value indexing engine 135 may, in one or more embodiments, receive non-industry standard pricing data 113 from a data source separate from the industry standard pricing data 111. For example, a merchant or vendor may have additional data relevant to the non-fungible good, such as a diamond, that may affect the pricing. This data could be responsible sourcing data, supply and demand data, internal sales data, information related to current events, or any other information outside of the industry standard data 111 that may affect the price or value of the non-fungible product.

According to embodiments, industry standard pricing data 111 may be received in a different format than non-industry standard pricing data 111. One of the industry standard pricing data 111 or the non-industry standard pricing data 113 may be converted into the format of the other of the industry standard pricing data 111 or the non-industry standard pricing data 113 (e.g., at or by the value indexing engine 135, by a separate component or module, etc.). For example, the non-industry standard pricing data 113 may be received by a formatting component that identifies attributes of the non-industry standard pricing data 113 (e.g., based on character recognition, machine learning, etc.). The attributes of the non-industry standard pricing data 113 may be extracted and converted into a format that matches the industry standard pricing data 111 and/or another acceptable format. Alternatively, or in addition, the format for both the industry standard pricing data 111 and the non-industry standard pricing data 113 may be modified to a value indexing format.

Next, a weight factor may be determined by the value indexing engine 135. The weight factor may be determined based on one or more of industry standard pricing data 111, non-industry standard pricing data 113, and characteristics data 112, and/or external factors (e.g., industry trends, marketing, current events, etc.). In some embodiments, the value indexing engine 135 may receive and apply the weight factor. The weight factor may be a factor or percentage that is applied to generate a par value as discussed further below. For example, the weight factor could be equal to 1.1, and could be applied to a wholesale price that may be initially generated based on the industry-standard pricing data 111 and the non-industry standard pricing data 113. For example, the wholesale price may be received via the industry-standard pricing data 111 and may be categorized as a wholesale related price via the non-industry standard pricing data 113. Accordingly, a weight factor may be applied to normalize the price by removing a wholesale based discount. The weight factor may be output by a machine learning model trained based on historical industry-standard pricing data, historical non-industry standard pricing data, historical weight factors, and/or historical prices.

Next, the value indexing engine 135 may determine a first par value for a first cell associated with a non-fungible product based on the industry standard pricing data 111, the non-industry standard pricing data 113, and/or other factors. For example, the industry standard pricing data might include values for a particular diamond with specific characteristics, such as a 1 carat Round, Excellent, Internally Flawless, D. Using an industry-standard pricing data 111, by way of example, may result in the cell having a par value of $18,200. The value indexing engine 135 may modify this industry-standard price based on non-industry standard pricing data 113 to generate a more accurate value for a diamond. For example, a merchant may have access to internal sales data suggesting that diamonds having properties associated with a cell are selling for more (or less) than indicated in the industry pricing chart. As another example, unusual market factors may impact the actual price and availability of a particular diamond cut, which may further be factored into the par value for the corresponding cell. Using the example above, outliers may be removed, resulting in a more accurate price of, for example, $16,350 dollars for the same cell. Then, a weight factor may be applied to the cell, such as 1.10. The par value would thus be 1.10*$16,350=$17,985. Accordingly, an accurate and reliable par value may be quickly generated in real time using the value indexing engine 135.

In some embodiments, the non-fungible product or diamond is screened and securely stored. For example, the diamond and a corresponding GIA certificate may be audited in order to determine authenticity and accuracy of the certificate, to ensure, for example, that the certificate is not forged or that the diamond was not damaged since it was graded by the GIA. Further, the diamond may also be analyzed for other gemological properties (e.g., clouding) that may not have been considered in the GIA 4C's grading scale. Once the diamond is fully audited, it may be stored in a secure location to prevent any tampering or damage to the diamond.

Value indexing engine 135 may then generate or associate an identifier with the non-fungible product, and the identifier may be used to identify the non-fungible product at marketplace 160 of FIG. 1. According to an example, the value indexing engine 135 may then generate a first blockchain non-fungible token, associate the NFT with the first non-fungible product, such as a diamond, and present that NFT on an online marketplace. The first non-fungible product in some embodiments is audited and securely stored in a secure location prior to generating the NFT. As explained above, an NFT is a unique, non-interchangeable unit of data stored on a block chain. For example, the NFT can be generated and sold in an Ethereum based market, such as on marketplace 160. Other forms of unique identification, other than or in addition to NFTs, may also be used.

Next, a price associated with the non-fungible product may be received. The price may be an offer price received from a seller looking to sell the non-fungible product via a marketplace 160. The price may be received at a value index engine 135 to determine a value index for the non-fungible product based on the price (e.g., prior to publishing the price via marketplace 160) and a par value associated with a cell corresponding to the non-fungible product.

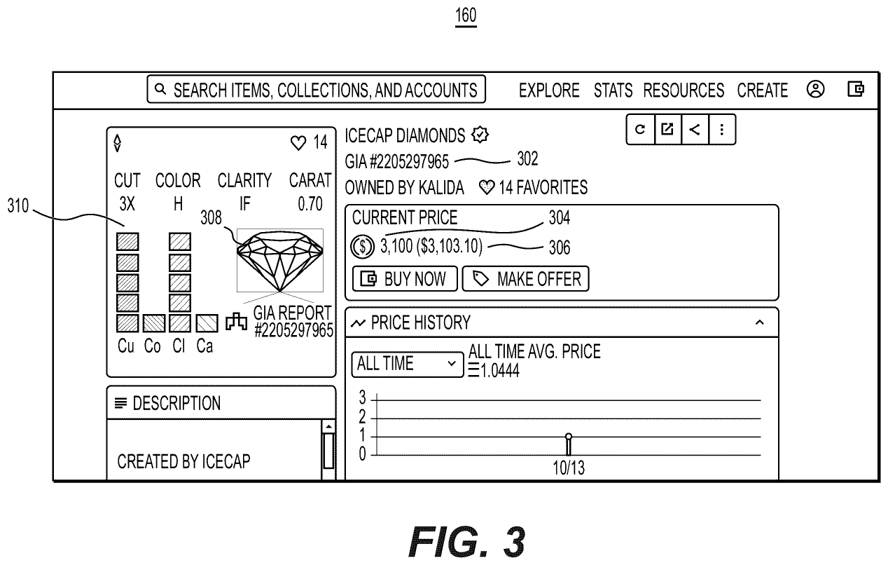

As shown in FIG. 3, a diamond may be presented via marketplace 160 and may be associated with one or more identifiers such as identifier 302. As shown in FIG. 3, an offer price 304 and a public par value 306 for a cell associated with the diamond may be provided via marketplace 160. In some embodiments, a plurality of par values may be generated for a plurality of cells based on corresponding diamond properties associated with each respective cell. In this manner, a marketplace is generated where multiple diamonds are made available in real-time and identified via their respective identifiers (e.g., NFTs.). In addition to displaying the cell par value 306, a picture of the diamond 308 and other rankings or information or characteristics 310 of the diamond may be displayed. For example, a graphical depiction of the 4Cs may also be provided as the rankings or information or characteristics 310. In this manner, the diamond may be presented with all applicable information, including par value 306, for a given diamond (e.g., associated with a corresponding NFT).

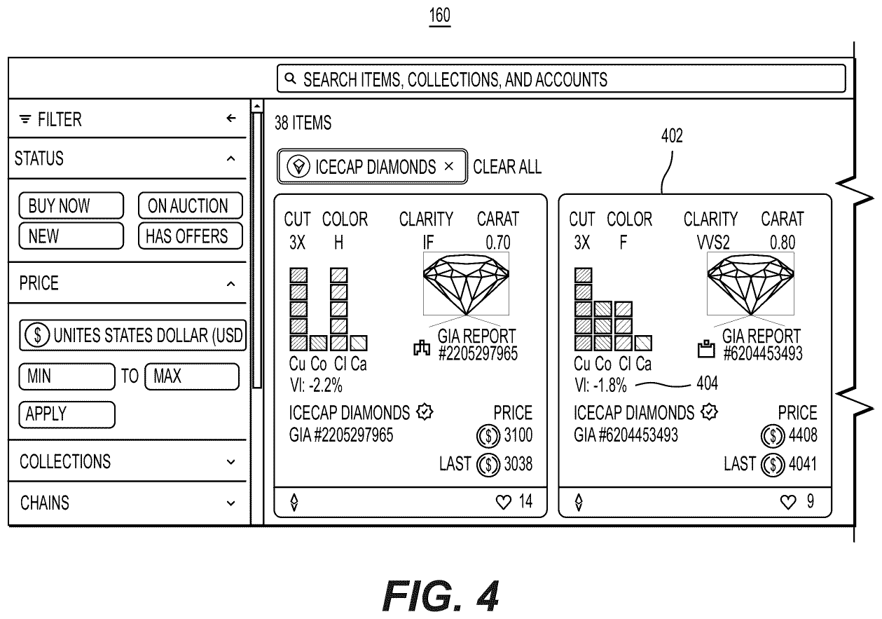

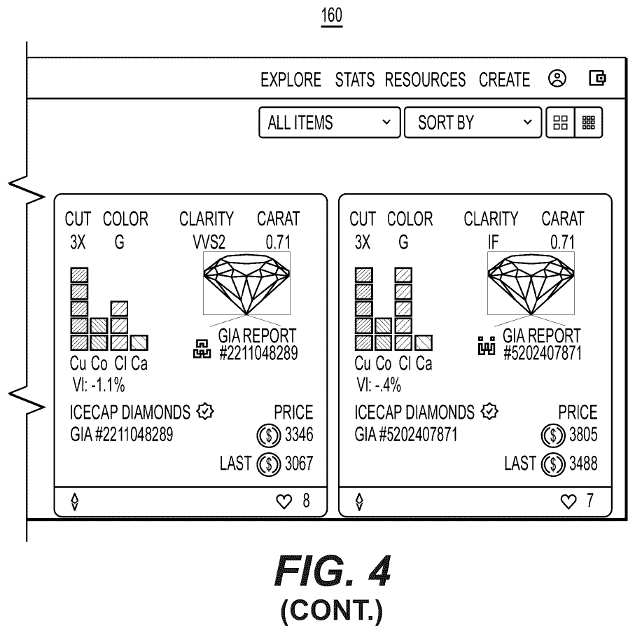

Next, the value indexing engine 135 may generate a value index for a given diamond based on its cell's par value and a given offer price associated with the given diamond. As shown via marketplace 160 shown in FIG. 4, a given diamond 402 may be presented based on its value index 404 determined based on its cell's par value and offer price, as discussed in reference to FIG. 3. As shown via marketplace 160 of FIG. 4, multiple diamonds may be ordered based on their respective value indexes such as the value index 404 of given diamond 402.

As discussed herein, the value index may be a value index ratio and may be generated based on the offer price and the par value of a cell corresponding to the non-fungible product. For example, the value index could be the offer price divided by the par value times 100. In other examples, the value index could be the offer price minus the par value, divided by the total value of the diamond, and multiplied by a factor of 100. For example, if the offer price is $3100, and the par value is $3103, the value index could be (3100-3103)/3100*1000=−0.967. As another embodiment, the value index may be calculated as a percent relationship to par. For example, (3100-3103)/3103*100=−0.0967% , such that the value index is considered “−0.0967% under par.” In other words, according to these examples, a larger the percentage below par (e.g., a larger negative value) represents a greater value (e.g., to a potential buyer). In some embodiments, if the value index of a diamond (e.g., as represented by an NFT) exceeds all other available diamonds, then the marketplace may indicate that the diamond has the best value index and/or rank the diamonds by value index (e.g., as shown in FIG. 4). In this manner, a buyer accessing marketplace 160 may determine that a diamond with the highest (e.g., most negative) value index may represent a best deal. Similarly, the seller or owner of the diamond may also be provided information regarding how much a given diamond is to be priced in order to increase the probability of selling the diamond (e.g., by improving its value index). Further, a marketplace vendor or operator may automatically submit purchase offers at a preset price for a single diamond with the highest value index (e.g., at a slightly discounted rate) in order to ensure that a seller holder can price their diamond to obtain cash, further improving liquidity. For example, in this scenario, a seller may not need to find a buyer for an exact diamond to be sold. Instead, the seller may sell the diamond to any other investor seeking the best deal (e.g., based on the value index) on a diamond, regardless of the 4Cs of the diamond.

According to an embodiment, a non-fungible product (e.g., a diamond) with a highest value index may become a focal point of a corresponding marketplace. Investors and/or bidders may focus on one or more top non-fungible products at any given time, saving resources and avoiding inefficient bidding on many different diamonds having many different properties.

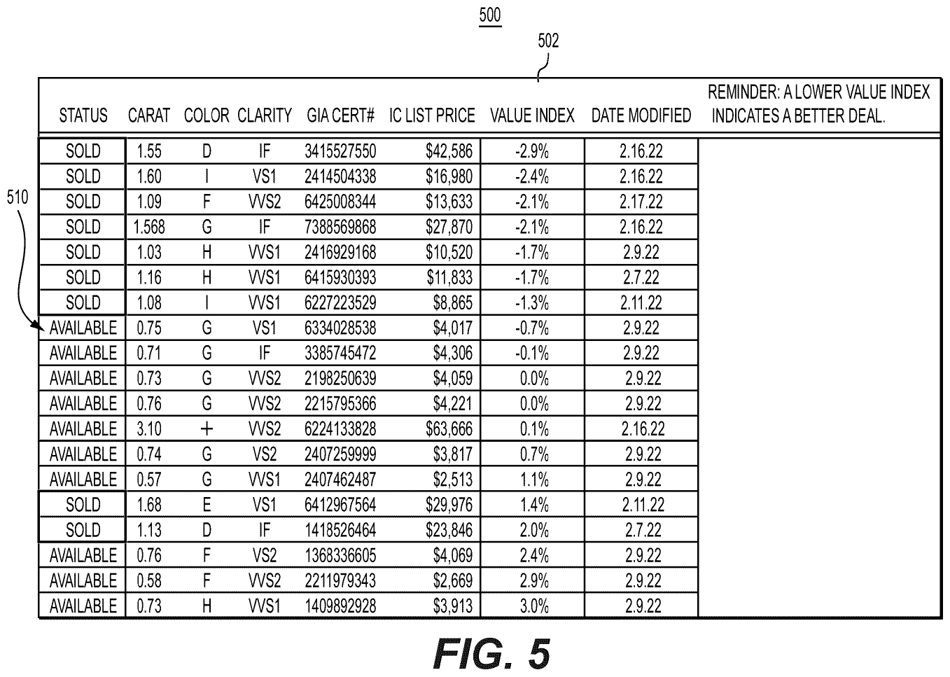

FIG. 5 shows example rankings 500 for NFTs and corresponding diamonds, according to one or more embodiments. As shown, diamonds available or sold on a marketplace (e.g., marketplace 160) may be ranked by the value index 502, as described above. As shown in FIG. 5, the diamonds with the largest negative value index 502 may be more likely to be sold. For example, a diamond 510 representing the best value currently available for sale (e.g., not sold) may has a value index of −0.07%.

In some embodiments, a non-fungible item holder may automatically be notified of the sales price needed for a particular non-fungible item in order for the non-fungible item to have the highest value index. In some embodiments, a notification may be generated and provided via an electronic message or graphical user interface (GUI) or dashboard. In other embodiments, an interface may be generated whereby a seller or non-fungible item holder may be provided a change in the sales price that would result in the non-fungible item to have a top position/highest value index. In some embodiments, all non-fungible goods in a non-fungible goods category (e.g., diamonds) may be ranked and presented in an ordered format, such that upon a buyer accessing the marketplace, the non-fungible good with the best or highest value index appears highest or first on the list. Accordingly, a GUI may be generated such that the content presented via the GUI is ordered based on value index in order of highest to lowest value and may further be ordered based on availability. Value indexes for non-fungible product in a non-fungible product category may be determined based on machine learning outputs having par values for corresponding cells associated with non-fungible products. The machine learning output par values may be compared to offer prices for the non-fungible goods to generate value indexes. The GUI may be dynamically generated such that non-fungible goods are presented in an order based on their respective value indexes and are automatically re-ordered based on a change to the value indexes.

In some embodiments, a suggested offer price for a non-fungible product may be provided to a seller (e.g., via an interface). The suggested offer price may be a price that may improve the value index (e.g., by a certain amount, to reach a highest value index, etc.) of the non-fungible product. In some embodiments, a seller may be provided a selectable option to automatically adjust an offer price in order to maintain a non-fungible product's position in ranking for the non-fungible category. For example, the price for the non-fungible product may be automatically lowered to ensure that the non-fungible product remains at the top until it is sold (e.g., as generally experienced in fungible marketplaces). In some embodiments, a marketplace interface may allow buyers and sellers to automatically purchase or sell diamonds when a threshold value index or par value is met. For example, a buyer may provide an instruction to purchase a non-fungible product if a threshold value index is met. The instruction may be automatically triggered when the value index for a non-fungible product meets the threshold value index. In some embodiments, an interface such as a dashboard may be displayed to a seller showing real-time data including the par value of the diamond, its offer price, its value index, historical pricing and appreciation/depreciation values, liquidation prices per non-fungible product (e.g., the price at which the non-fungible product should be priced to have the highest or best value index), as well as set other automatic functions for purchasing or selling non-fungible products.

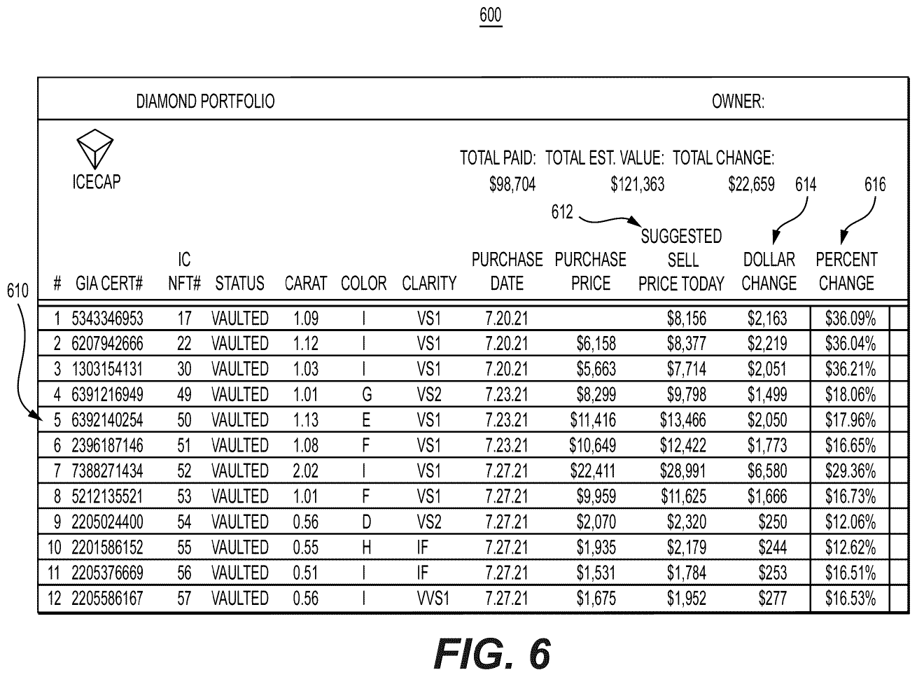

In some embodiments, marketplace 160 may provide a user with access to a list of all non-fungible products in a given category that have been previously purchased, including transaction details such as price paid, date of transactions, diamond characteristics, and so forth. Marketplace 160 may further provide a “suggested offer price if sold today” to the customer, based on the value index for the day, where the suggested price is the price needed for the non-fungible product to be at the top of the value index ranking described above. Alternatively, or in addition, the suggested value may be provided to a user via an interface on a webpage, via a push notification, a text message, or other means of conveniently notifying a user of the value, or potential value changes, of the user's diamond investment. An exemplary interface 600 is shown in FIG. 6.

As shown in interface 600 of FIG. 6, a user of a marketplace may own a portfolio of diamond investments. A marketplace vendor may provide the user with the list of diamonds 610 including, for example, GIA certificate numbers, status, NFT number (e.g., if NFT identifiers are being used), characteristics information, and a purchase price. A “suggested sell price today” 612 may further be generated based on the value index determined in accordance with the techniques disclosed above. For example, the “suggested sell price today” may be an offer price that would result in a diamond being ranked first on the list with respect to value. Further, a dollar change 614 and percent price value change 616 may be provided to the user. In this manner, an improved method for creating virtual fungibility is provided that provides investors with usable information necessary to easily and securely purchase and liquidate diamonds as an investment.

The disclosed techniques and systems provide a technical solution to a technical problem of providing fungibility to non-fungible products. By analyzing data by machine learning, an improved digital marketplace is created that provides security and liquidity to investors in non-fungible products such as diamonds. Absent the disclosed systems and techniques herein, a buyer may not to know which non-fungible product to purchase from a value/investment perspective due to non-fungible properties of a non-fungible product and confusing pricing. Further, the disclosed techniques and systems disclosed herein enable a seller to know, ahead of time, how to price a non-fungible product to move it to the top of the ranking, thereby ensuring the likelihood that the non-fungible product may be the next one purchased by a potential investor. The disclosed technology, including the use of NFTs as disclosed herein, further permits this activity to occur in real-time. Because only one non-fungible product may be at the top of the queue at any given time, a non-fungible product marketplace operator may, for example, only display an offer price to the top ranked diamond, and not all the diamonds on the market. Further, the seller may not need a real-time offer on their non-fungible products at all times, because they may already know the price at which they need to price the diamond in order to be at the top of the ranking. Further, a seller may provide a current spread between the top ranked non-fungible products and offers for purchase made on the top ranked non-fungible products.

As disclosed herein, NFTs may allow anonymity in purchase and sale transactions. The transaction themselves may be secured by a blockchain, resulting in a highly secure and trustworthy method of transfer of the non-fungible products.

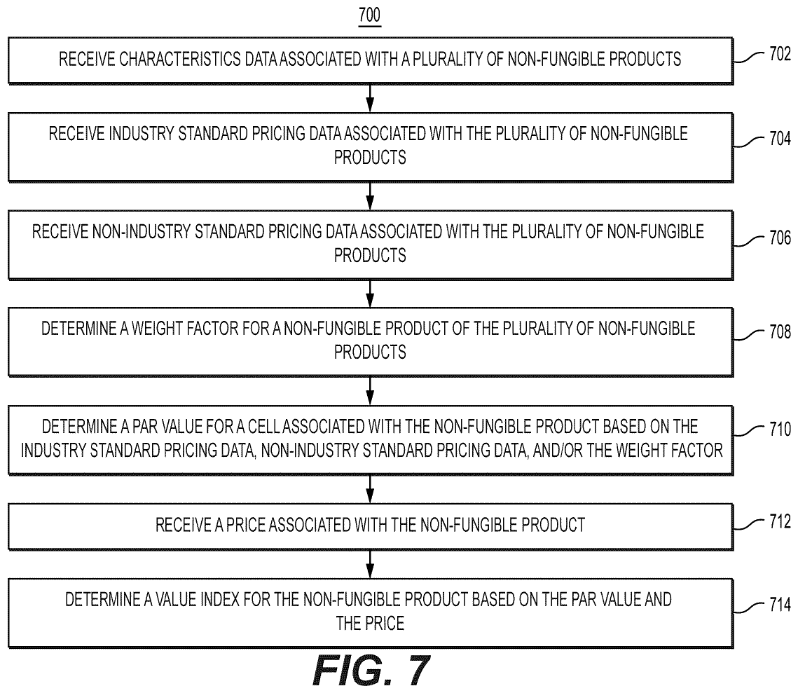

FIG. 7 shows a flowchart 700 for determining a value index for non-fungible products in accordance with the techniques disclosed herein. As shown in FIG. 7, at step 702, characteristics data associated with a plurality of non-fungible products in a given non-fungible product category may be received. The characteristics data may be provided from a first data source (e.g., a database, a server, etc.) and may be provided over a network.

At step 704, industry standard pricing data associated with the plurality of non-fungible products may be provided from a second data source (e.g., a database, a server, etc.) and may be provided over a network. At step 706, non-industry standard pricing data associated with the plurality of non-fungible products may be provided from a third data source (e.g., a database, a server, etc.) and may be provided over a network. The first, second, and third data sources may be the same or similar data sources or may be different data sources.

At step 708, a weight factor for a given non-fungible product of the plurality of non-fungible products may be determined. The weight factor may be determined in accordance with the techniques disclosed herein and may be based on one or more of the characteristics data, industry standard pricing data, or non-industry standard pricing data. The weight factor may be determined to adjust pricing information to account for external factors such as industry trends, marketing trends, current events, discount adjustments, and/or the like.

At step 710, a par value for the given cell associated with one or more non-fungible products may be determined based on one or more of the characteristics data, industry standard pricing data, or non-industry standard pricing data. The par value may be determined in a standardized manner such that the par value for each cell is determined in the same way as each other par value for each other cell in a given non-fungible product category. The par value may be output by a machine learning model based on inputs including one or more of the characteristics data, industry standard pricing data, or non-industry standard pricing data. The machine learning model may be trained in accordance with the techniques disclosed herein.

At step 712, a price associated with the non-fungible product may be received. The price may be set by a user (e.g., seller), may be retrieved from a price source, or the like. At step 714, a value index for the non-fungible product may be determined based on the par value and the price (e.g., offer price), as disclosed herein. The value index for the non-fungible product may be used to rank the non-fungible product relative to other non-fungible products in the given non-fungible product category. The value index may be applied by a non-fungible product marketplace to rank non-fungible products within the non-fungible product category. The value index may be used to provide automated features in accordance with the techniques disclosed herein.

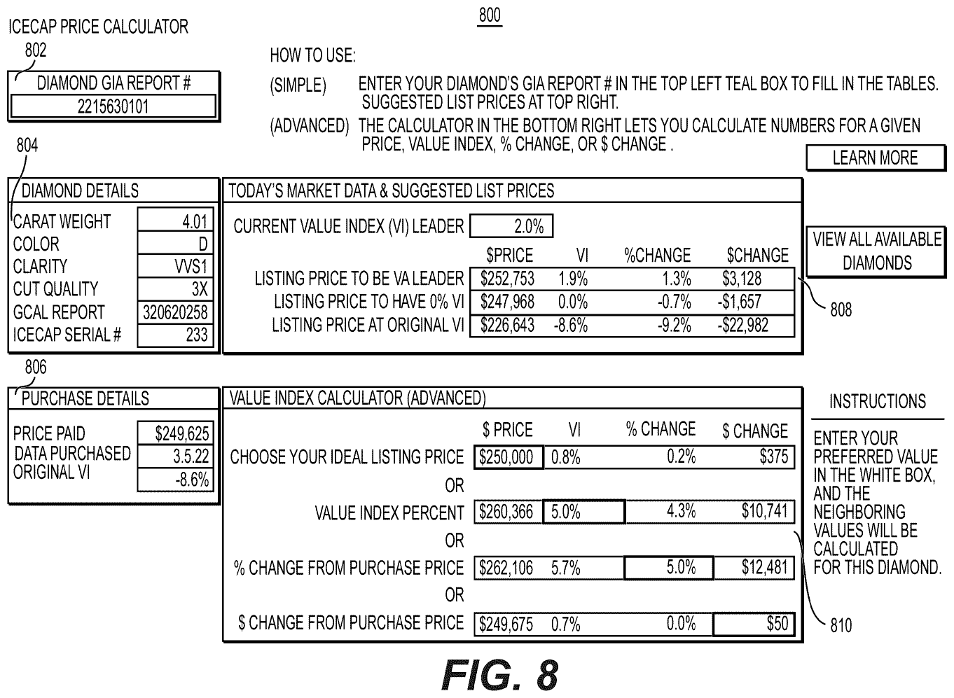

FIG. 8 shows an example implementation of a value index generator 800 (e.g., a proprietary pricing generator) for diamonds. As shown, an identifier 802 (e.g., a GIA number, an NFT identifier, etc.) may be input at value index generator 800. Based on the identifier 802, the value index generator 800 may be populated including diamond details 804, purchase history 806, market data 808, and value index calculator 810 associated with the identifier 802.

A user may use value index generator 800 to determine a current value index leader, listing price required to become the value index leader, listing price to have a 0% value index, and listing price at an original value index, as shown via market data 808. The user may modify one or more fields of value index calculator 810 to determine a price to price a given diamond. A user may generate a suggested asking price based on user inputs such as a target value index rating, a percent return based on the purchase price (e.g., as provided via diamond details 804), a target gain based on purchase price (e.g., to obtain a target profit), and/or a target price, as shown in value index calculator 810. Value index generator 800 may automatically generate values for variables based on the user inputs.

Value index generator 800 may be implemented based on the virtual fungibility market implemented in accordance with the techniques disclosed herein. For example, value index generator 800 may generate values for variables based on marketplace data generated in accordance with the technique disclosed herein. It will be understood that the value indexes output by value index generator 800 may be based on dynamic changes to the marketplace, such as current value index, par prices, sales, and the like. As shown via the example value index generator 800 of FIG. 8, an objective value index, rather than other subjective factors (e.g., price, non-fungible good properties, marketing, etc.) may be used as a one-dimensional factor (a value index) to make purchase decisions. Accordingly, an efficient buyer and seller market is created based on value index based comparisons.

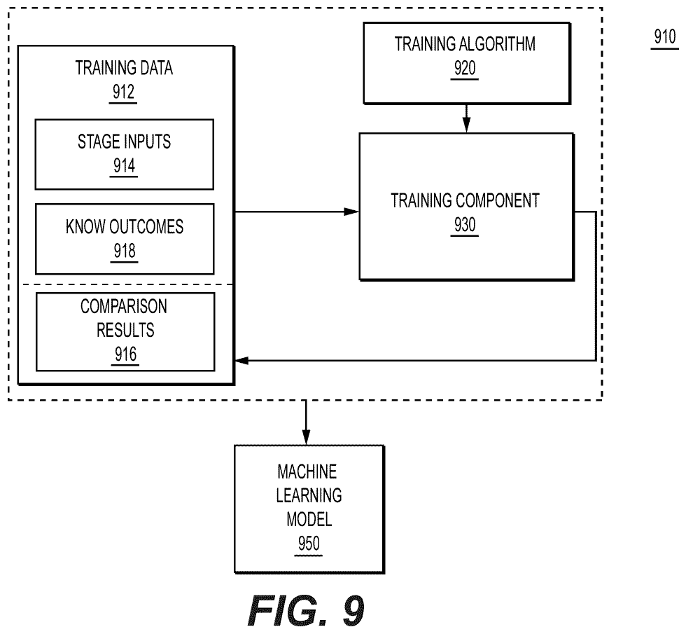

One or more implementations disclosed herein may be implemented using a machine learning model 950 of FIG. 9. Such a machine learning model may be trained using the data flow 910 of FIG. 9. Training data 912 may include one or more of stage inputs 914 and known outcomes 918 related to a machine learning model to be trained. The stage inputs 914 may be from any applicable source including data input or output from a component, step, or module discussed herein and/or as shown in FIGS. 1-8. The known outcomes 918 may be included for machine learning models generated based on supervised or semi-supervised training. An unsupervised machine learning model may not be trained using known outcomes 918. Known outcomes 918 may include known or desired outputs for future inputs similar to or in the same category as stage inputs 914 that do not have corresponding known outputs.

The training data 912 and a training algorithm 920 may be provided to a training component 930 that may apply the training data 912 to training algorithm 920 to generate a machine learning model. According to an implementation, training component 930 may be provided comparison results 916 that compare a previous output of the corresponding machine learning model to apply the previous result to re-train the machine learning model. Comparison results 916 may be used by training component 930 to update the corresponding machine learning model. Training algorithm 920 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. Training algorithm 920 and/or the training disclosed in FIG. 9 may be used to modify one or more of weights, layers, nodes, synopsis, or the like of an initial machine learning model to generate machine learning model 950 based on the training data 912 and training component 930.

A number of implementations have been described. Nevertheless, it will be understood that various modifications may be made without departing from the spirit and scope of the disclosure. For example, various forms of the flows shown above may be used, with steps re-ordered, added, or removed.

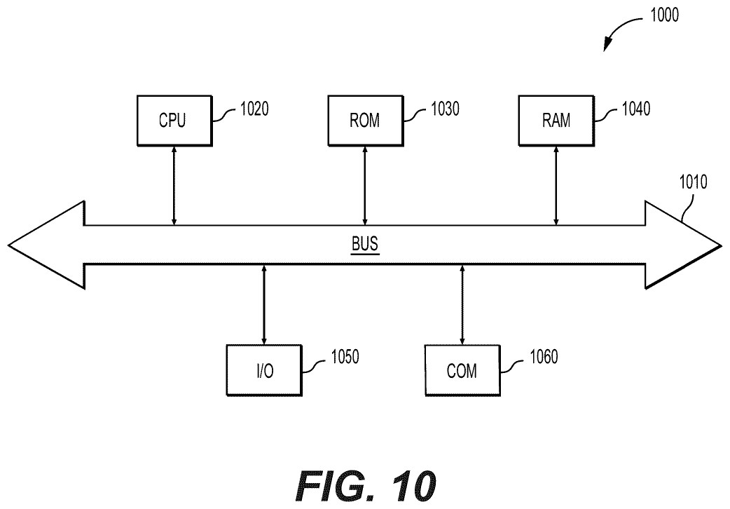

FIG. 10 depicts a high-level functional block diagram of an exemplary computer device or system, in which embodiments of the present disclosure, or portions thereof, may be implemented, e.g., as computer-readable code. Additionally, each of the exemplary computer servers, databases, user interfaces, modules, and methods described above with respect to FIGS. 1-9 can be implemented in device 1000 using hardware, software, firmware, tangible computer readable media having instructions stored thereon, or a combination thereof and may be implemented in one or more computer systems or other processing systems. Hardware, software, or any combination of such may implement each of the exemplary systems, user interfaces, and methods described above with respect to FIGS. 1-9.

If programmable logic is used, such logic may be executed on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor or a plurality of processors, or combinations thereof. Processor devices may have one or more processor “cores.”

Various embodiments of the present disclosure, as described above in the examples of FIGS. 1-10, may be implemented using device 1000. After reading this description, it will become apparent to a person skilled in the relevant art how to implement embodiments of the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As shown in FIG. 10, device 1000 may include a central processing unit (CPU) 1020. CPU 1020 may be any type of processor device including, for example, any type of special purpose or a general-purpose microprocessor device. As will be appreciated by persons skilled in the relevant art, CPU 1020 also may be a single processor in a multi-core/multiprocessor system, such system operating alone, or in a cluster of computing devices operating in a cluster or server farm. CPU 1020 may be connected to a data communication infrastructure 1010, for example, a bus, message queue, network, or multi-core message-passing scheme.

Device 1000 also may include a main memory 1040, for example, random access memory (RAM), and also may include a secondary memory 1030. Secondary memory 1030, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 1030 may include other similar means for allowing computer programs or other instructions to be loaded into device 1000. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 1000.

Device 1000 also may include a communications interface (“COM”) 1060. Communications interface 1060 allows software and data to be transferred between device 1000 and external devices. Communications interface 1060 may include a modem, a network interface (such as an Ethernet card), a communications port, a PCMCIA slot and card, or the like. Software and data transferred via communications interface 1060 may be in the form of signals, which may be electronic, electromagnetic, optical, or other signals capable of being received by communications interface 1060. These signals may be provided to communications interface 1060 via a communications path of device 1000, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 1000 also may include input and output ports 1050 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

It should be appreciated that in the above description of exemplary embodiments of the disclosure various features of the disclosure are sometimes grouped together in a single embodiment, figure, or description thereof for the purpose of streamlining the disclosure and aiding in the understanding of one or more of the various disclosed aspects. This method of disclosure, however, is not to be interpreted as reflecting an intention that the claimed disclosure requires more features than are expressly recited in each claim. Rather, as the following claims reflect, disclosed aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the disclosure, and it is intended to claim all such changes and modifications as falling within the scope of the disclosure. For example, functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method for creating virtual fungibility between non-fungible products, comprising:
receiving characteristics data associated with a plurality of non-fungible products;
receiving industry standard pricing data associated with the plurality of non-fungible products;
receiving non-industry standard pricing data from a data source separate from the industry standard pricing data;
determining a first cell, from a plurality of cells, associated with the first non-fungible product;
determining a weight factor for a first cell;
determining a first par value for the first cell based on the industry standard pricing data, the non-industry standard pricing data, and the weight factor;
associating a first identifier with the first non-fungible product; and
generating a first value index for the first non-fungible product based on the first par value and a first offer price associated with the first non-fungible product.

2. The computer-implemented method of claim 1, further comprising causing a display of the first identifier and one or more of the first value index, the first par value, or the first offer price via an online marketplace.

3. The computer-implemented method of claim 1, further comprising:
generating a first blockchain non-fungible token (NFT);
associating the first NFT with the first non-fungible product based on the identifier; and
presenting the first NFT via an online marketplace.

4. The computer-implemented method of claim 1, further comprising:
determining a second par value for a second cell associated with a second non-fungible product based on the industry pricing data, the non-industry pricing data, and the weight factor;
associating a second identifier with the second non-fungible product;
generating a second value index for the second non-fungible product based on the second par value and a second offer price associated with the first non-fungible product; and
causing display of the second identifier ordered based on the second value index for the second non-fungible product, on an online marketplace.

5. The computer-implemented method of claim 4, further comprising:
comparing the first value index and the second index; and
based on the comparing:
ranking the first non-fungible product and the second non-fungible product; and
determining a highest ranked non-fungible product between the first non-fungible product and the second non-fungible product.

6. The computer-implemented method of claim 5, further comprising automatically executing a transaction for the highest ranked non-fungible product based on determining the highest ranked non-fungible product between the first non-fungible product and the second non-fungible product.

7. The computer-implemented method of claim 5, further comprising:
associating the first non-fungible product with a first seller;
upon determining that the second non-fungible product is the highest ranked non-fungible product, determining a suggested sale price for the first non-fungible product; and
presenting the suggested sale price for the first non-fungible product to the first seller.

8. The computer-implemented method of claim 7, further comprising:
automatically changing the first offer price to the suggested sale price for the first non-fungible product;
determining an updated first value ratio for the first non-fungible product;
determining that the first non-fungible product is a new highest ranked non-fungible product between the first non-fungible product and the second non-fungible product; and
automatically generating a notification indicating the new highest ranked non-fungible product.

9. The computer-implemented method of claim 1, wherein the non-fungible product is a diamond, and the industry pricing data is diamond pricing data.

10. The computer-implemented method of claim 1, wherein the weight factor is determined based on one or more of the characteristics data, the industry standard pricing data, the non-industry standard pricing data, or external factors.

11. The computer-implemented method of claim 1, wherein the first par value is output by machine learning model based on inputs to the machine learning model comprising the industry standard pricing data, the non-industry standard pricing data, and the weight factor.

12. A computer-implemented method for creating virtual fungibility between diamonds, comprising:
receiving characteristics data for each diamond of a plurality of diamonds;
receiving industry pricing data associated with the plurality of diamonds;
receiving non-industry pricing data from a data source separate from the industry pricing data;
determining a respective cell for each diamond of the plurality of diamonds;
determining a weight factor for each respective cell; determining par values for each respective cell based on the characteristics data, the industry pricing data, the non-industry pricing data, and respective weight factors for each respective cell of the plurality of cells;
generating an identifier for each diamond of the plurality of diamonds;
receiving an offer price associated with each generated identifier;
determining a value index for each generated identifier based on the determined par value and the offer price associated with each generated identifier;
ranking each generated identifier based on a corresponding value index of each generated identifier; and
presenting the ranking of the generated identifiers on an online marketplace.

13. The computer-implemented method of claim 12, wherein the par values for each cell is output by a trained machine learning model based on inputs comprising the characteristics data, the industry pricing data, the non-industry pricing data, and the weight factors.

14. The computer-implemented method of claim 13, wherein the trained machine learning model is trained to determine the par values for each cell based on (i) the inputs and (ii) and relative data that includes one or more other par values corresponding to the respective cells and corresponding characteristics information for each of the one or more other diamonds, to learn associations between the inputs and relative data, such that the trained machine learning model is configured to use the learned associations to determine the par values for each of the cells in response to the inputs.

15. The computer-implemented method of claim 12, further comprising generating a suggested offer price for a first identifier of the generated identifiers for each diamond based on a first value index for the first identifier and a highest value index for a second identifier having a highest value index of the value indexes for each identifier.

16. The computer-implemented method of claim 12, further comprising generating a suggested offer price for a first identifier of the generated identifiers for each diamond based on one of a target value index for the first identifier.

17. A computer-implemented method for creating virtual fungibility between non-fungible products, comprising:
receiving characteristics data for each non-fungible product of a plurality of non-fungible products;
receiving industry pricing data associated with the plurality of non-fungible products;
receiving non-industry pricing data from a data source separate from the industry pricing data;
determining a respective cell, from a plurality of cells, for each non-fungible product of the plurality of non-fungible products;
determining a weight factor for each respective cell of the plurality of cells;
determining par values for each respective cell of the plurality of cells based on the characteristics data, the industry pricing data, the non-industry pricing data, and respective weight factors for each of non-fungible product of the plurality of non-fungible products;
generating a blockchain non-fungible token (NFT) for each non-fungible products of the plurality of non-fungible products;
receiving an offer price associated with each generated NFT;
determining a value index for each generated NFT based on the determined par value and the offer price associated with each generated NFT;
ranking each generated NFT based on a corresponding value index for each generated NFT; and
presenting the ranking of the generated NFTs on an online marketplace.

18. The computer-implemented method of claim 17, wherein the par values for each respective cell is output by a trained machine learning model based on inputs comprising the characteristics data, the industry pricing data, the non-industry pricing data, and the weight factors.

19. The computer-implemented method of claim 18, wherein the trained machine learning model is trained to determine the par values for each respective cell of the plurality of cells based on (i) the inputs and (ii) and relative data that includes one or more other par values corresponding to one or more other cells and corresponding characteristics information, to learn associations between the inputs and relative data.

20. The computer-implemented method of claim 17, wherein each NFT of the plurality of NFTs is be created using cryptographic hashes on sets of data linked to previous records on a blockchain.
